(19) United States
(12) Patent Application Publication
(10) Pub. No.: US 2025/0309553 A1
(43) Pub. Date: Oct. 2, 2025

(54) METHOD FOR DRIVING RADIO-WAVE REFLECTOR

(71) Applicant: Japan Display Inc., Tokyo (JP)

(72) Inventors: Mitsutaka OKITA, Tokyo (JP); Daijiro TAKANO, Tokyo (JP); Masayuki IKARI, Tokyo (JP)

(73) Assignee: Japan Display Inc., Tokyo (JP)

(21) Appl. No.: 19/177,785

(22) Filed: Apr. 14, 2025

Related U.S. Application Data
(63) Continuation of application No. PCT/JP2023/032663, filed on Sep. 7, 2023.

(30) Foreign Application Priority Data
Nov. 15, 2022 (JP) 2022-182599

(51) Int. Cl. H01Q 15/14; H01Q 15/24

(52) U.S. Cl. CPC H01Q 15/148; H01Q 15/24

(57) ABSTRACT

A driving method of a radio-wave reflector includes: supplying a common potential to a second electrode over a plurality of continuous frame periods; supplying scanning signals to first to mth scanning lines in each of the plurality of frame periods; and supplying control signals to a plurality of radio-wave reflecting elements through first to nth signal lines in each of the plurality of frame periods. A polarity of the common potential is inverted every j frame periods. The scanning signals are supplied in a first order from the first to nth signal lines or a second order from the nth to first signal lines. The first order and the second order are interchanged every k frame periods. m and n are each selected from natural numbers equal to or greater than 2, and j and k are selected from natural numbers equal to or greater than 1.

### CROSS-REFERENCE TO RELATED APPLICATIONS

This application is a Continuation of International Patent Application No. PCT/JP2023/032663, filed on Sep. 7, 2023, which claims the benefit of priority to Japanese Patent Application No. 2022-182599, filed on Nov. 15, 2022, the entire contents of each are incorporated herein by reference.

### FIELD

An embodiment of the present invention relates to a driving method of a radio-wave reflector.

### BACKGROUND

Since liquid crystal molecules have permittivity anisotropy, the permittivity of a liquid crystal layer can be controlled by adjusting an electric field applied to the liquid crystal layer containing liquid crystal molecules to control the orientation of the liquid crystal molecules. Metasurfaces which utilize these characteristics to control reflection characteristics of a liquid crystal layer with respect to radio waves have been known (see, for example, Japanese laid-open patent publications No. H11-103201 and 2019-530387).

### SUMMARY

An embodiment of the present invention is a driving method of a radio-wave reflector. The radio-wave reflector includes a first scanning line to a mth scanning line, a first signal line to a nth signal line, and a plurality of radio-wave reflecting elements. The plurality of radio-wave reflecting elements is electrically connected to respective scanning lines and signal lines and each includes a first electrode, a second electrode and a liquid crystal layer sandwiched by the first electrode and the second electrode. The driving method includes: supplying a common potential to the second electrode over a plurality of continuous frame periods; supplying scanning signals to the first scanning line to the mth scanning line in each of the plurality of frame periods; and supplying control signals to the plurality of radio-wave reflecting elements through the first signal line to the nth signal line in each of the plurality of frame periods. A polarity of the common potential is inverted every j frame periods. The scanning signals are supplied in a first order from the first signal line to the nth signal line or a second order from the nth signal line to the first signal line. The first order and the second order are interchanged every k frame periods. m and n are each selected from natural numbers equal to or greater than 2, and j and k are selected from natural numbers equal to or greater than 1.

### BRIEF DESCRIPTION OF DRAWINGS

FIG. 1 is a schematic top view of a radio-wave reflector according to an embodiment of the present invention.

FIG. 2 is a schematic cross-sectional view of a radio-wave reflector according to an embodiment of the present invention.

FIG. 3 is a schematic top view for explaining a driving method of a radio-wave reflector according to an embodiment of the present invention.

FIG. 4A is a schematic cross-sectional view for explaining a driving method of a radio-wave reflector according to an embodiment of the present invention.

FIG. 4B is a schematic cross-sectional view for explaining a driving method of a radio-wave reflector according to an embodiment of the present invention.

FIG. 5A is a schematic view for explaining a driving method of a radio-wave reflector according to an embodiment of the present invention.

FIG. 5B is a schematic view for explaining a driving method of a radio-wave reflector according to an embodiment of the present invention.

FIG. 6 is a timing chart showing a driving method of a radio-wave reflector according to an embodiment of the present invention.

FIG. 7 is a timing chart showing a driving method of a radio-wave reflector according to an embodiment of the present invention.

FIG. 8 is a timing chart showing an example of a driving method of a radio-wave reflector.

FIG. 9 is a timing chart showing a driving method of a radio-wave reflector according to an embodiment of the present invention.

FIG. 10 is a timing chart showing a driving method of a radio-wave reflector according to an embodiment of the present invention.

FIG. 11 is a timing chart showing a driving method of a radio-wave reflector according to an embodiment of the present invention.

FIG. 12 is a timing chart showing a driving method of a radio-wave reflector according to an embodiment of the present invention.

FIG. 13 is a timing chart showing a driving method of a radio-wave reflector according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

### 1. Structure of Radio-Wave Reflector

Hereinafter, a structure of a radio-wave reflector according to an embodiment of the present invention is explained. This radio-wave reflector is a so-called liquid-crystal metasurface reflector and is a device utilizing a permittivity change resulting from a change of orientation of a liquid crystal layer caused by an electric field, thereby reflecting incident radio waves in an arbitrary direction. The frequency of the wavelengths to be reflected is not limited and may be in a range from 400 MHz to 50 GHz, for example. Typically, the present radio-wave reflector may be utilized for reflection of radio waves in the 400 MHz to 6.0 GHz band, the 2.5 GHz to 4.7 GHz band, and the 24 GHz to 50 GHz band.

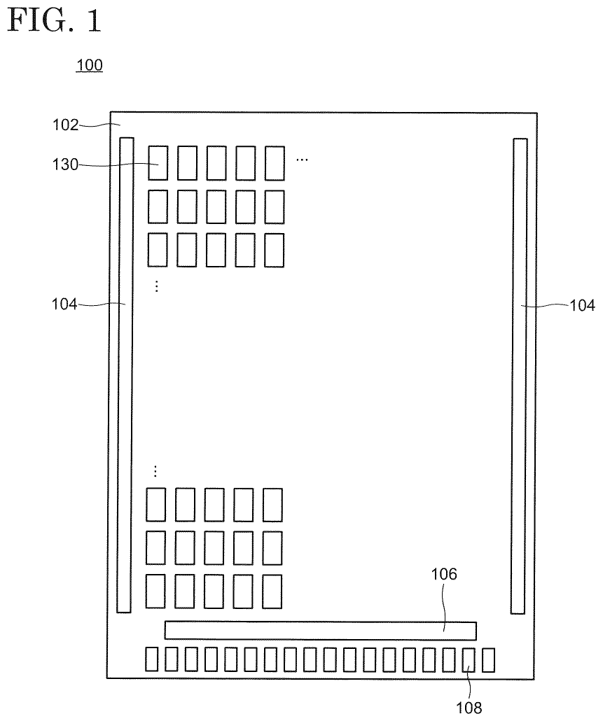

FIG. 1 shows a schematic top view of the radio-wave reflector 100. The radio-wave reflector 100 has a substrate 102 and a counter substrate which is not illustrated in FIG. 1, and a variety of patterned insulating films, semiconductor films, and conductive films is formed therebetween. Appropriate stack of these films allows the formation of a plurality of radio-wave reflecting elements 130 arranged in a matrix form with m rows and n columns. In addition to the radio-wave reflecting elements 130, the radio-wave reflector 100 has a scanning-line driver circuit 104 and a signal-line driver circuit 106 for respectively supplying scanning signals and control signals to the radio-wave reflecting elements 130. The scanning-line driver circuit 104 and the signal-line driver circuit 106 may be formed with the insulating films, the semiconductor films, and the conductive films formed over the substrate 102 or by mounting an integrated circuit formed over a semiconductor substrate over the substrate 102. One or a plurality of scanning-line driver circuits 104 may be provided, and in the latter case, two scanning-line driver circuits 104 may be arranged over the substrate 102 so as to sandwich the plurality of radio-wave reflecting elements 130 as shown in FIG. 1. The signal-line driver circuit 106 is placed on a side of an edge of the substrate 102. Here, m and n are independently selected from natural numbers equal to or greater than 2.

A plurality of scanning lines and a plurality of signal lines (which are not illustrated in FIG. 1) respectively extend from the scanning-line driver circuit 104 and the signal-line driver circuit 106 and are electrically connected to the radio-wave reflecting elements 130. Accordingly, the radio-wave reflecting elements 130 are electrically connected to the corresponding scanning lines and signal lines. A plurality of terminals 108 are further provided over the substrate 102, and a variety of signals for driving the radio-wave reflecting elements 130 is supplied through the terminals 108 from an external circuit which is not illustrated. The scanning-line driver circuit 104 and the signal-line driver circuit 106 generate scanning signals and control signals on the basis of the supplied signals and supply these signals to the radio-wave reflecting elements 130.

### 2. Structure of Radio-Wave Reflecting Element

### (1) Overall Structure

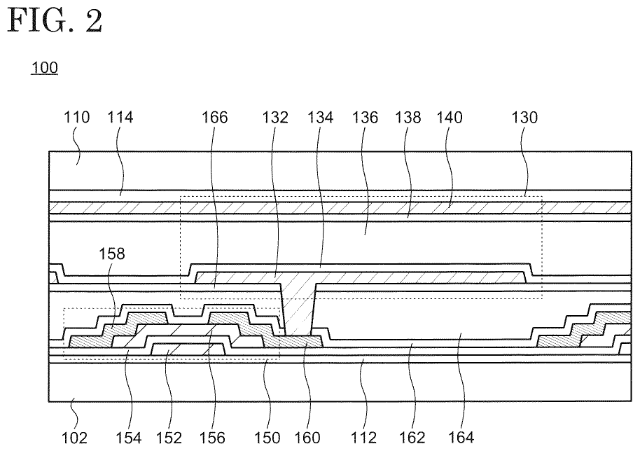

FIG. 2 shows a schematic view of a part of a cross-section of the radio-wave reflector 100. Each of the radio-wave reflecting elements 130 is connected to an element circuit including at least one transistor. Each element circuit may include a plurality of transistors and one or a plurality of capacitive elements. In the example shown in FIG. 2, one transistor 150, one radio-wave reflecting element 130 connected thereto, and a part of an adjacent radio-wave reflecting element 130 are illustrated.

As can be understood from FIG. 2, the element circuit and the radio-wave reflecting element 130 are provided over the substrate 102 either directly or through an undercoat 112 which is an optional component. The transistor included in the element circuit is not restricted in structure and may be a bottom-gate type transistor or a top-gate type transistor. Alternatively, the transistor may be a transistor having gate electrodes over and under a semiconductor film. The transistor exemplified in FIG. 2 is a bottom-gate type transistor and is composed of a gate electrode 152, a gate insulating film 154 over the gate electrode 152, a semiconductor film 156 over the gate insulating film 154, and a pair of terminals 158 and 160 over the semiconductor film 156. A planarization film 164 is provided over the transistor 150, and a radio-wave reflecting element 130 is disposed thereover. As an optional component, interlayer insulating films 162 and 166 may be provided between the transistor 150 and the planarization film 164 and over the planarization film 164, respectively.

The radio-wave reflecting element 130 has a first electrode (also called a patch electrode) 132, a first orientation film 134 over the first electrode 132, a liquid crystal layer 136 over the first orientation film 134, a second orientation film 138 over the liquid crystal layer 136, and a second electrode 140 over the second orientation film 138. The second electrode 140 is provided over the counter substrate 110 (under the counter substrate 110 in FIG. 2) directly or through an overcoat 114 which is an optional component. The first electrode 132 is electrically connected to the transistor 150 through an opening formed in the interlayer insulating film 162 and the planarization film 164, by which control signals are supplied from the signal-line driver circuit 106 to the radio-wave reflecting element 130. These components are described below.

### (2) Substrate and Counter Substrate

The substrate 102 and the counter substrate 110 are used to provide physical strength to the radio-wave reflector 100 and a surface for arranging the radio-wave reflecting elements 130. The substrate 102 and the counter substrate 110 may include inorganic insulators such as glass and quartz, semiconductors such as silicon, polymers such as a polyimide, a polycarbonate, and a polyester, or metals such as aluminum, copper, and stainless steel. When conductive materials such as metals are included, a film containing an insulator such as silicon oxide and silicon nitride is preferably formed as the undercoat 112 or the overcoat 114 over the surface where the radio-wave reflecting elements 130 are provided, i.e., the surface of the substrate 102 on the counter substrate 110 side and the surface of the counter substrate 110 on the substrate 102 side. The substrate 102 and the counter substrate 110 may or may not transmit visible light. The substrate 102 and the counter substrate 110 may have flexibility.

### (3) Transistor

The gate electrode 152, the gate insulating film 154, the semiconductor film 156, the terminals 158 and 160 as well as the interlayer insulating films 162, 166 and the planarization film 164 covering the transistor 150 may be formed by using known materials and applying known methods as appropriate. Therefore, a detailed description is omitted. In brief, the gate electrode 152 and the terminals 158 and 160 are formed by forming a film containing a metal such as tantalum, molybdenum, titanium, and aluminum using a sputtering method, a chemical vapor deposition (CVD) method, or the like, followed by patterning this film as appropriate using a photolithographic process. The semiconductor film 156 is formed as a film containing a Group 14 element exemplified by silicon or an oxide of a Group 13 element such as indium and gallium. The semiconductor film 156 may also be formed by applying a sputtering method or a CVD method. The gate insulating film 154 and the interlayer insulating films 162 and 166 include a silicon-containing inorganic compound such as silicon oxide and silicon nitride and are formed by applying a sputtering method or a CVD method. The planarization film 164 includes a polymer such as an acrylic resin, an epoxy resin, a polyimide, a polyamide, and a silicon resin and may be formed by applying a wet film-forming method such as a spin-coating method, an inkjet method, and a printing method as appropriate. The formation of the planarization film 164 allows the radio-wave reflecting element 130 to be formed on a flat surface.

### (4) Radio-Wave Reflecting Element

The control signal supplied from the signal line is supplied to the first electrode 132 of the radio-wave reflecting element 130 via the transistor 150. The first electrode 132 includes, for example, a metal such as copper, aluminum, tungsten, molybdenum, and titanium or an alloy including at least one of these metals. Alternatively, the first electrode 132 may include a conductive oxide having light-transmitting properties such as indium-zinc oxide (IZO) and indium-tin oxide (ITO). The first electrode 132 may have a single-layer structure or a stacked-layer structure of layers of different compositions. For example, a stacked structure of a layer containing a conductive oxide and a layer containing the above metal or alloy may be employed. Alternatively, the first electrode 132 may have a mesh shape in order to provide a light-transmitting property to the radio-wave reflector 100 containing the metal or alloy.

The first orientation film 134 disposed over the plurality of first electrodes 132 is provided in order to control the orientation of the liquid crystal molecules structuring the liquid crystal layer 136 provided thereover. The first orientation film 134 may be continuously formed over the plurality of radio-wave reflecting elements 130. In other words, the first orientation film 134 may be provided so as to be undivided between adjacent radio-wave reflecting elements 130 and to be shared by all of the radio-wave reflecting elements 130.

The first orientation film 134 includes a polymer such as a polyimide and a polyester. The first orientation film 134 is formed by utilizing a wet film-formation method such as an ink-jet method, a spin-coating method, a printing method, and a dip-coating method, and a surface thereof is subjected to a rubbing treatment. Alternatively, the first orientation film 134 may be formed by a photo-alignment process.

The liquid crystal layer 136 contains liquid crystal molecules. The structure of the liquid crystal molecules is not limited. Thus, the liquid crystal molecules may be nematic liquid crystals, smectic crystals, cholesteric crystals, or chiral smectic liquid crystals. The thickness of the liquid crystal layer 136 is, for example, equal to or greater than 20 μm and equal to or less than 50 μm, or equal to or greater than 30 μm and equal to or less than 50 μm. Although not illustrated, spacers may be provided in the liquid crystal layer 136 to maintain its thickness throughout the radio-wave reflector 100. Note that, when the thickness of the liquid crystal layer 136 described above is employed in a liquid crystal display device, the high responsiveness required to display moving images cannot be obtained, and it becomes significantly difficult to realize the functions of a liquid crystal display device.

The second orientation film 138 is also provided to control the orientation of the liquid crystal molecules and has the same configuration as the first orientation film 134. The second orientation film 138 may also be continuous over adjacent radio-wave reflecting elements 130 and may be formed to be shared by the plurality of radio-wave reflecting elements 130. The first orientation film 134 and the second orientation film 138 are arranged so that the direction in which the first orientation film 134 orients the liquid crystal molecules is parallel to that of the second orientation film 138. The liquid crystal molecules are oriented in a certain direction by the first orientation film 134 and the second orientation film 138.

The second electrode 140 is supplied with a common potential from an external circuit (not illustrated) directly or via the signal-line driver circuit 106. The difference between the potential of the control signal provided to the first electrode 132 and the common potential generates an electric field in the liquid crystal layer 136, and this electric field causes the liquid crystal molecules to orient, thereby controlling the permittivity of the liquid crystal layer 136. Similar to the first electrode 132, the second electrode 140 may include, for example, a metal such as copper, aluminum, tungsten, molybdenum, and titanium, an alloy including at least one of these metals, or a conductive oxide such as ITO and IZO. The second electrode 140 may also have a single-layer structure or a stacked-layer structure with layers of different compositions. The second electrode 140 may also be formed by applying a sputtering method or a CVD method. The second electrode 140 may be provided for each of the radio-wave reflecting elements 130 or may be provided as a single electrode integrated over the plurality of radio-wave reflecting elements 130 to be shared by the plurality of elements 130. Therefore, the second electrode 140 is also referred to as a common electrode. Note that the radio-wave reflecting elements 130 may or may not transmit visible light. For example, visible light may be blocked by using, for the first electrode 132 and the second electrode 140, a metal or an alloy having a thickness which does not allow visible light to pass therethrough.

### 3. Driving Method of Radio-Wave Reflector

### (1) Control of Reflection Direction

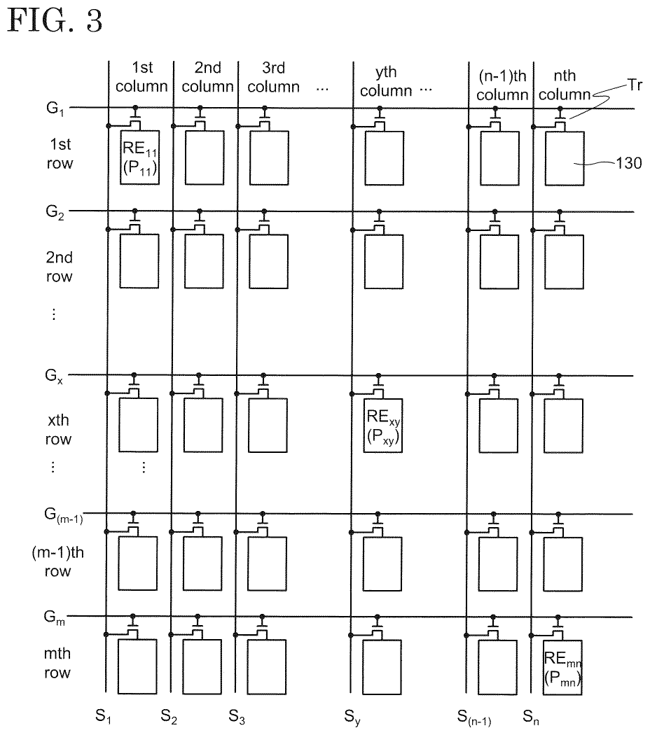

Hereinafter, the driving method of the radio-wave reflector 100 is described. FIG. 3 shows a schematic top view showing the arrangement of the radio-wave reflecting elements 130 in the radio-wave reflector 100. As described above, the plurality of radio-wave reflecting elements 130 is arranged in a matrix form with m rows and n columns. The scanning lines G₁ to Gₘ, which are each arranged to supply the scanning signal to the transistors Tr connected to the plurality of radio-wave reflecting elements 130 arranged in each row, extend from the scanning-line driver circuit 104. In addition, the source lines S₁ to Sₙ, which are each arranged to supply the control potential to the transistors Tr connected to the plurality of radio-wave reflecting elements 130 located in each row, extend from the signal-line driver circuit 106. The radio-wave reflecting elements 130 located in each row are connected to the same scanning line G via the element circuits, and the radio-wave reflecting elements 130 located in each column are connected to the same source line S via the element circuits. The transistor Tr shown in FIG. 3 is a switching transistor for controlling the on-off of each element circuit and may be the transistor 150 (see FIG. 2.) connected to the radio-wave reflecting elements 130 or a transistor different from the transistor 150. Therefore, the transistor Tr may be directly connected to the radio-wave reflecting element 130 or may be connected to the radio-wave reflecting element 130 via another transistor or a capacitive element. The element circuit is opened and the control signal is supplied to the first electrode 132 of each radio-wave reflecting element 130 via the signal lines S₁ to Sₙ when the scanning signal is supplied to the gate of the transistor Tr via the scanning line G, thereby controlling the potential of the first electrode 132 of each of the radio-wave reflecting elements 130. Hereafter, the radio-wave reflecting element 130 arranged in a xth row and a yth column may be denoted as RE_{xy}, and the potential of the control signal supplied to the radio-wave reflecting element RE_{xy} may be denoted as P_{xy}. Here, x and y are variables and are natural numbers selected from 1 to m and 1 to n, respectively.

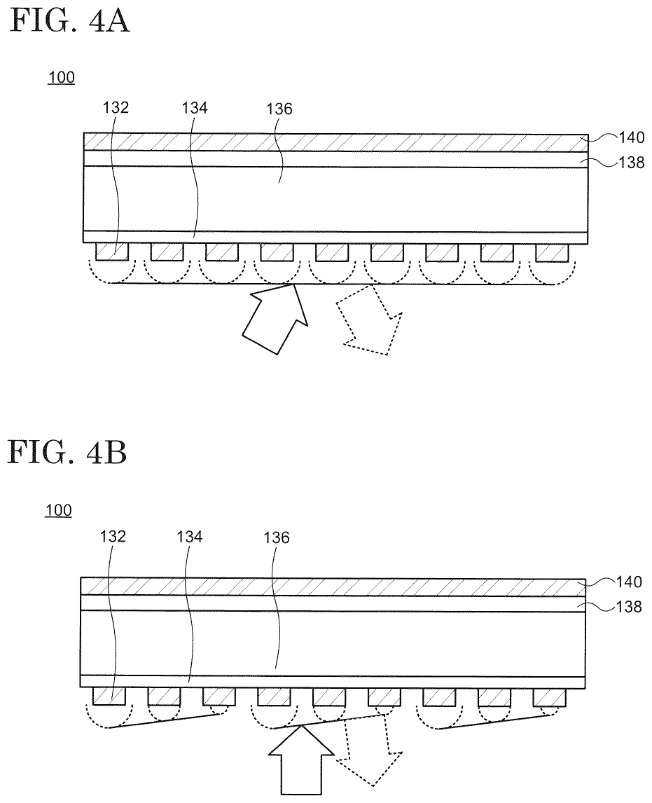

As described above, the first orientation film 134 and the second orientation film 138 orient the liquid crystal molecules in the same direction in the radio-wave reflector 100. Hence, when no potential difference is applied between the first electrode 132 and the second electrode 140, no vertical electric field is generated in the liquid crystal layer 136, and the liquid crystal molecules are splay-oriented. The orientation of the liquid crystal layer 136 is the same between the radio-wave reflecting elements 130, and thus the permittivity is also constant within the liquid crystal layer 136. Therefore, as represented by the dotted arcs in FIG. 4A which is a schematic cross-sectional view of the plurality of radio-wave reflecting elements 130, no change occurs in the spread (phase) of the reflected waves which are generated when radio waves (solid white arrow in FIG. 4A) incident from the first electrode 132 side are reflected on the surface of the second electrode 140. As a result, the incident radio waves are regularly reflected by the radio-wave reflector 100, giving reflected waves (dotted white arrow in FIG. 0.4A) with the same incident angle as the incident angle.

In contrast, when a potential difference is applied between the first electrode 132 and the second 140 electrode, the generated vertical electric field causes the liquid crystal molecules to rise and bend-orientate. When the vertical electric fields with different intensity are generated between the radio-wave reflecting elements 130, the permittivity of the liquid crystal layer 136 changes between the radio-wave reflecting elements 130 according to the intensities of the vertical electric fields. As a result, the phase of the reflected waves changes as shown by the dotted arcs in FIG. 4B, which in turn changes the reflection direction of the incident radio waves (solid white arrow in FIG. 4B) (see dotted white arrow in FIG. 4B). The reflection direction can be controlled by changing the intensities of the vertical electric fields formed in the radio wave reflecting elements 130.

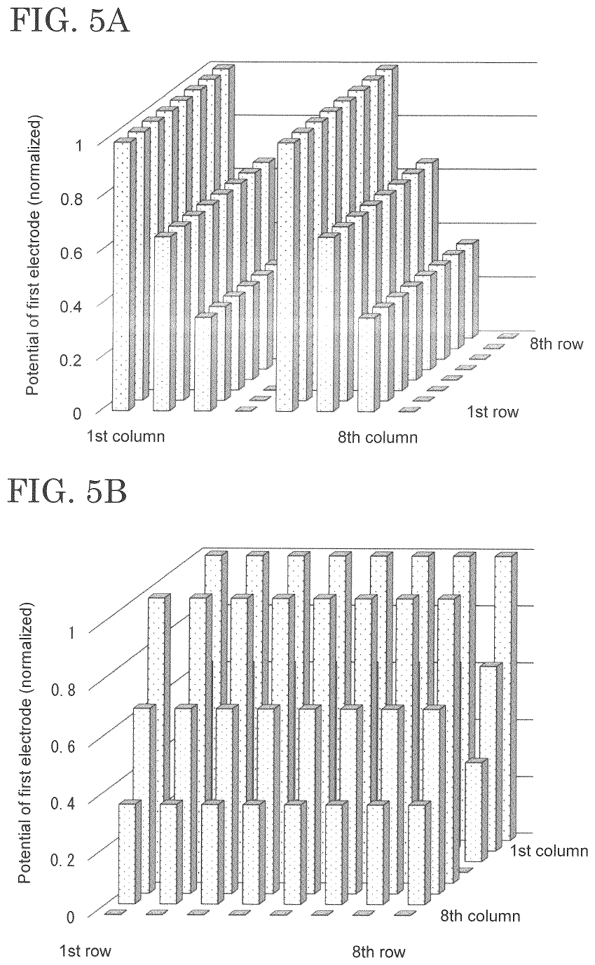

When controlling the reflection direction of the radio waves incident on the radio-wave reflector 100, the permittivity of the liquid crystal layer 136 is changed periodically and stepwise. The orientation of the liquid crystal molecules is determined by the absolute value of the difference between the potential of the control signal and the common potential. Therefore, when the potentials of the control signals supplied to the first electrodes 132 of the radio-wave reflecting elements 130 arranged in 8 rows and 8 columns are periodically and stepwise changed in the row direction, while fixing the common potential supplied to the second electrode 140, for example, the radio waves can be reflected in the direction rotated about an axis parallel to the column direction (axis perpendicular to the scanning line G). Similarly, the radio waves can be reflected in the direction rotated about an axis parallel to the row direction (axis parallel to the scanning line G) by periodically and stepwise changing the potentials of the control signals in the column direction (FIG. 5B).

### (2) COM-Inversion Driving

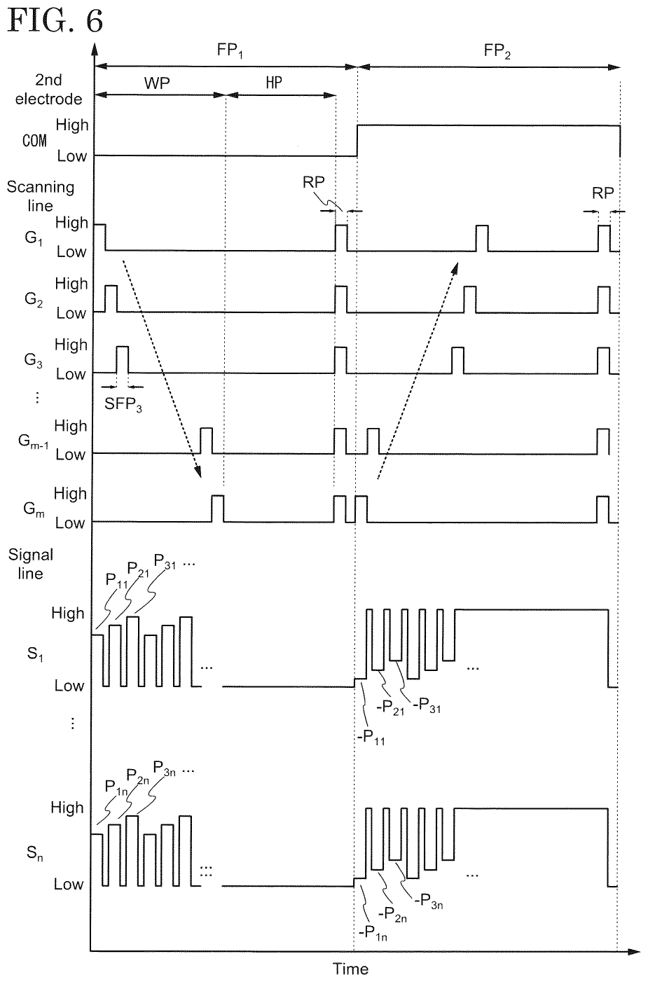

FIG. 6 shows an example of a timing chart showing the present driving method. This chart depicts the potential change of the second electrode 140 and the potential changes of the scanning lines G and the signal lines S over two frame periods (first frame period FP₁ and second frame period FP₂) of a plurality of frame periods having a constant duration. The duration of each frame period is appropriately selected from a range of, for example, 1/180 second to 1 second.

Each frame period includes m subframe periods SFP₁ to SFPₘ. In each subframe period, the scanning signal is supplied from each scanning line G. When the potential of the scanning signal becomes the potential to open each element circuit (for convenience, this potential is hereinafter referred to as High), the control signals are supplied from the signal lines S to n radio-wave reflecting elements 130 located in the row supplied with the scanning signal. The period during which the control signals are supplied to all of the radio-wave reflecting elements 130 in each frame period, i.e., the time required by all of the subframe periods SFP₁ to SFPₘ to elapse, is a writing period WP. As described above, since the potentials of the control signals are determined by the direction in which radio waves are reflected, the potential of the control signal supplied from one signal line may be varied periodically and stepwise every subframe period as illustratively shown in FIG. 6. The absolute value of the potential of the control signal is appropriately selected from a range equal to or higher than 0 V and equal to or lower than 20 V, for example. In the case where radio waves are regularly reflected, the potential of the control signal may be constant in each frame period because the permittivity may be constant across the entire liquid crystal layer 136.

When the writing in each row is completed, the potential of the scanning line G becomes the potential to close the element circuits (for convenience, this potential is hereinafter referred to as Low). When the element circuit is closed, the potential of the first electrode 132 of each radio-wave reflecting element 130 is maintained by the element circuit for a certain period of time (holding period HP). In each frame period, when the holding period HP ends, all of the radio-wave reflecting elements 130 are reset. That is, the scanning signal of a potential High is supplied from all of the scanning lines G to open the element circuits, and a reset signal is simultaneously supplied from the signal lines S after the holding period HP. This period is called a reset period RP. The potential of the reset signal is set so that the potential of the first electrode 132 becomes the potential of the common potential (COM) of the second electrode 140.

On the other hand, in each frame period, the common potential is supplied to the second electrode 140. More specifically, either a positive potential (High) or a negative potential (Low) with respect to a reference potential such as a ground potential is supplied to the second electrode 140 as the common potential. The absolute value of the potential supplied to the second electrode 140 may be selected from a range equal to or higher than 0 V and equal to or lower than 20 V, for example.

The reflection direction of radio waves is determined by the amount of change in permittivity of the liquid crystal layer 136. Therefore, in this driving method, a common-potential inversion driving (COM inversion driving) is employed, in which the potential applied to the liquid crystal layer 136 can be increased to increase the electric field intensity in order to more significantly change the permittivity for the wide range control of the reflection direction. Specifically, the polarity of the common potential is changed every j frames. Here, j is independent from m and n, is selected from natural numbers equal to or greater than 1, and may be an odd number or an even number. The upper limit of j is 6, for example. The example shown in FIG. 6 is the case where j is 1, and the radio-wave reflector 100 is driven so that the common potential switches between High and Low every j frame periods, i.e., one frame period.

Therefore, the polarity of the control signal is also inverted every j frame periods simultaneously with the polarity inversion of the common potential. That is, when the common potential is Low (first frame period FP₁ in FIG. 6), the control signals having a positive potential with respect to the reference potential are supplied to the radio-wave reflecting elements 130 via signal lines S. On the other hand, when the common potential is High (second frame period FP₂ in FIG. 6), the control signals having a negative potential with respect to the reference potential are supplied to the radio-wave reflecting elements 130 via the signal lines S. For example, in the example shown in FIG. 6, the signal line S₁ supplies positive potentials P₁₁, P₂₁, P₃₁, in turn in the writing period WP of the first frame period FP₁ and supplies negative potentials P₁₁, P₂₁, −P₃₁, in turn in the writing period WP of the second frame period FP₂.

The same is applied to the reset signal potential, and the polarity of the reset signal is also inverted every j frame periods in the case where the polarity of the common potential is inverted every j frame periods. Therefore, the potential of the reset signal is Low in a frame period when the common potential is Low, while the potential of the reset signal is High in the frame period when the common potential is High.

### (3) Scanning-Direction Inversion Driving

Furthermore, in this driving method, the scanning direction is inverted every k frame periods in order to suppress the row dependence of the magnitude of the effective voltage, which is the product of the voltage applied to the liquid crystal layer 136 and the applied time thereof, and to reduce the difference in the effective voltage applied to the liquid crystal layer 136 between rows. In other words, the order in which the scanning signals are supplied to the scanning lines G (i.e., the order in which the High potential is supplied to open the element circuits.

The same is applied hereinafter) is switched every k frame periods (scanning-direction inversion driving). Specifically, in each frame period, the scanning signals are supplied to m scanning lines G in either the first order of the first scanning line G₁, the second scanning line G₂, and the mth scanning line or the second order of the mth scanning line, the (m−1)th scanning line, and the first scanning line. In addition, the first order and the second order are interchanged every k frame periods. Here, k is independent from j, m, and n, is a natural number equal to or greater than 1, and may be an even number or an odd number. The upper limit of k is 6, for example. In addition, k and j may be the same as or different from each other. In the latter case, k may be larger or smaller than j. In the example shown in FIG. 6, k is 1, and the first order and the second order are interchanged every frame period. Therefore, the scanning signals are supplied to the scanning lines G according to the first order and the second order in the first frame period FP₁ and the second frame period FP₂, respectively.

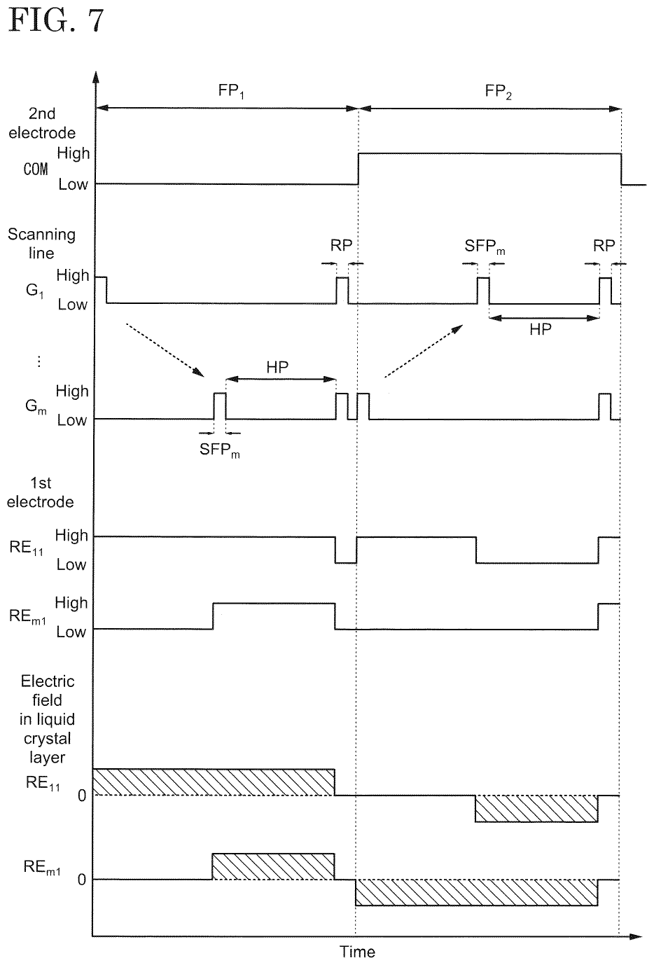

A timing chart of the case of driving the radio-wave reflector 100 according to the example demonstrated in FIG. 6 is shown in FIG. 7 which also includes the potential change of the first electrode 132 and the electric field change generated in the liquid crystal layer 136. In order to promote understanding, this timing chart shows the potential changes of the first electrodes 132 and the electric field change in the liquid crystal layer 136 of the radio-wave reflecting elements RE₁₁ and REₘ₁ respectively located in the first row and the first column and in the mth row and the first column. Note that, although the potentials of the control signals supplied to the first electrodes 132 are determined by the reflection direction of radio waves, a case where the potentials of the control signals are High or Low is explained for convenience.

In this example, the common potential of Low is supplied to the second electrode 140 in the first frame period FP₁, while scanning signals are supplied to the scanning lines G according to the first order. Therefore, after the potential of the first electrode 132 of the radio-wave reflecting element RE₁₁ located in the first row becomes High in the first subframe period SFP₁, this potential is maintained until the end of the holding period HP and then returns to Low in the reset period RP. On the other hand, the potential of the first electrode 132 of the radio-wave reflecting element REₘ₁ located in the mth row maintains Low until the mth subframe period SFPₘ and then becomes High in the mth subframe period SFPₘ. This potential is maintained until the end of the holding period HP and returns to Low in the reset period RP.

When the second frame period FP₂ successive to the first frame period FP₁ starts, the polarity of the common potential is inverted to High. At this time, since all of the first electrodes 132, which have the potential of Low at the time when the first frame period FP₁ ends, are capacitively coupled to the second electrode 140 through the liquid crystal layer 136, their potentials become High. However, the scanning signals are supplied to the scanning lines G according to the second order in the second frame period FP₂. Furthermore, since the polarity of the common potential is inverted, the polarity of the potentials of the control signals are also inverted. Therefore, the potential of the first electrode 132 of the radio-wave reflecting element REₘ₁, which is first written in the second frame period FP₂, remains Low until the reset period RP. On the other hand, the potential of the first electrode 132 of the radio-wave reflecting element RE₁₁, which has changed to High by capacitive coupling, returns to Low in the mth subframe period SFPₘ, and the potential of Low is maintained until the reset period RP.

Note that, in the above example, the first order is employed in the frame period in which the common potential is Low, while the second order is employed in the frame period in which the common potential is High. However, the second order may be employed in the frame period in which the common potential is Low, and the first order may be employed in the frame period in which the common potential is High.

When the radio-wave reflector 100 is driven in this manner, the High and Low periods differ between the rows, i.e., between the radio-wave reflection elements RE₁₁ and REₘ₁, in each of the first frame period FP₁ and the second frame period FP₂. Since the electric field generated in the liquid crystal layer 136 is determined by the potential difference between the first electrode 132 and the second electrode 140, the effective voltages applied to the liquid crystal layer 136 are different in each of the first frame period FP₁ and the second frame period FP₂, and the time periods when the electric field exists are also different between the radio-wave reflecting elements RE₁₁ and REₘ₁. Specifically, in the first frame period FP₁, the electric field is generated from the first subframe period SFP₁ to the end of the holding period HP in the radio-wave reflecting element RE₁₁, while the electric field is generated from the mth subframe period SFPₘ to the end of the holding period HP in the radio-wave reflecting element REₘ₁. Therefore, the electric field is generated for a longer time in the radio-wave reflecting element RE₁₁ than in the radio-wave reflecting element REₘ₁. This situation is reversed in the second subframe period SFP₂.

However, when accumulated over the first frame period FP₁ and the second frame period FP₂, the effective voltage and the electric field applied to the liquid crystal layer 136 are the same between the radio-wave reflecting elements RE₁₁ and REₘ₁. Therefore, the differences in effective voltage and electric field between the first row and the mth row are canceled over a plurality of frame periods including the first frame period FP₁ and the second frame period FP₂. Although an explanation is omitted, the same is applied to the radio-wave reflecting elements 130 located in the second row to the (m−1)th row. Hence, the row dependences of the difference in effective voltage and electric field are also canceled in all of the rows by this scan-direction inversion driving.

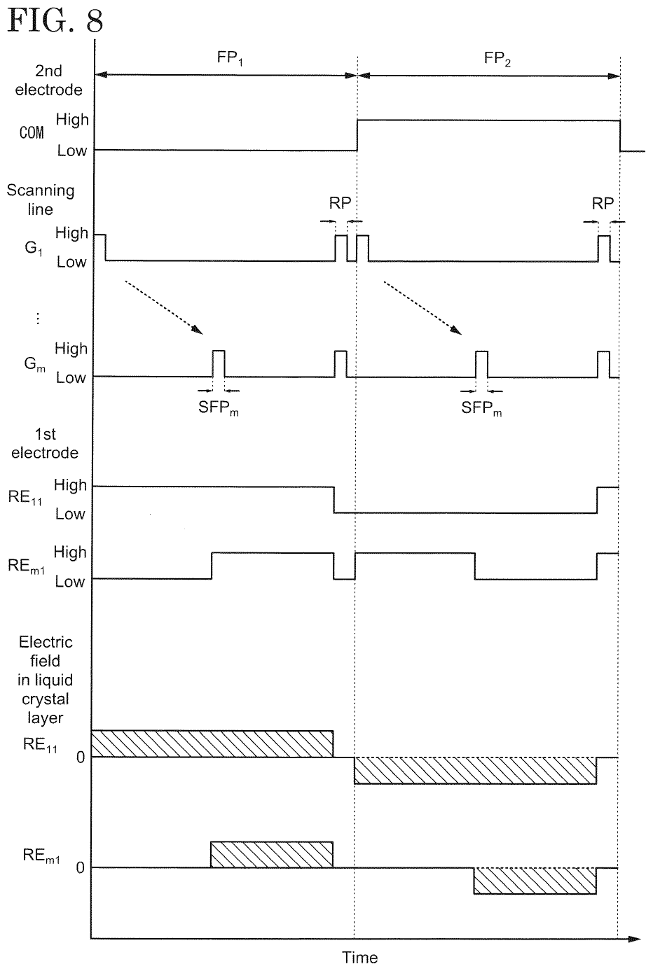

For comparison, a timing chart for the case where the scanning-direction inversion driving is not applied is shown in FIG. 8. In this case, the period in which the potential of the control signal potential is High is longer in the radio-wave reflecting element RE₁ in the first frame period FP₁ in which the common potential is Low, and the period in which the potential of the control signal is Low is also longer in the radio-wave reflecting element RE₁ in the second frame period FP₂ in which the common potential is High. Therefore, the effective voltage and the electric field applied to the liquid crystal layer 136 are greater in the radio-wave reflecting element RE₁₁ than in the radio-wave reflecting element REₘ₁ in any frame period, and these differences are not canceled even if the effective voltage and the electric field are accumulated over a plurality of frame periods. Therefore, even if the same signal is input, the actually set reflection phase is different depending on the rows. Accordingly, radio waves cannot be reflected in an intended direction, and a reduction in the reflection characteristics occurs.

As described above, since the scanning-direction inversion driving is performed in driving the radio-wave reflector 100 according to an embodiment of the present invention, the row dependences of the effective voltage and the electric field applied to the liquid crystal layer 136 are canceled by accumulating them over a plurality of frame periods. Therefore, it is possible to effectively suppress the degradation of the reflection characteristics.

Furthermore, in each frame period, the reset period RP is provided after the end of the holding period HP so that the potentials of the first electrodes 132 and the second 140 electrode are identical or substantially identical to each other as mentioned above. Although the potentials of the first electrodes 132 shift due to the inversion of the common potential when transitioning to the successive frame period, the problems caused by the potential shift can be prevented by providing the reset period RP. More specifically, when the potential of the second electrode 140 is inverted from Low to High, for example, the potentials of the first electrodes 132 also increase due to capacitive coupling. However, since the potentials of the first electrodes 132 are set to Low prior to the inversion of the common potential, this potential change is limited to a change from Low to High. The same is applied to the reverse case. Therefore, it is possible to prevent a potential change exceeding the breakdown voltages of a variety of elements such as the transistors and capacitive elements provided in the element circuit, and the destruction of the element circuit can be prevented.

### (4) Timing of Inversion

As described above, the polarity of the common potential and the scanning direction are inverted every j frame periods and k frame periods, respectively. Since j and k may be different, the timing of the polarity inversion of the common potential and the inversion of the scanning direction need not necessarily coincide.

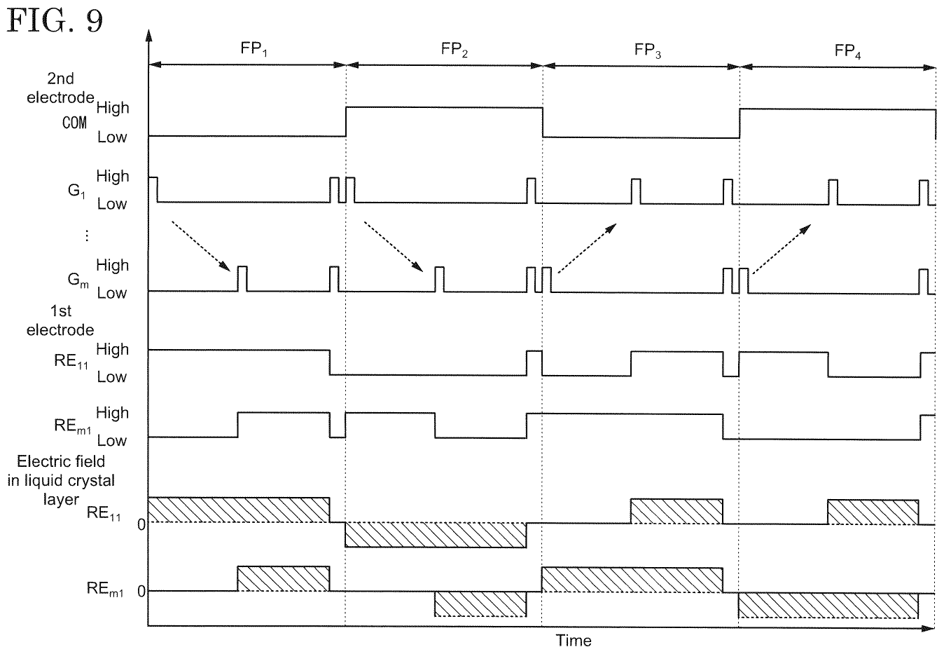

For example, the polarity of the common potential may be inverted every frame period, while the scanning direction may be inverted every multiple frame periods. As an example of this case, the case where j and k are respectively 1 and 2 is shown in FIG. 9. In this example, the polarity of the common potential is inverted every one frame period, while the scanning direction is inverted every two frame periods. In this case, the row dependences of the effective voltage and the electric field applied to the liquid crystal layer 136 can be canceled by accumulating a plurality of frame periods (here, four frame periods including at least the first frame period FP₁ to the fourth frame period FP₄).

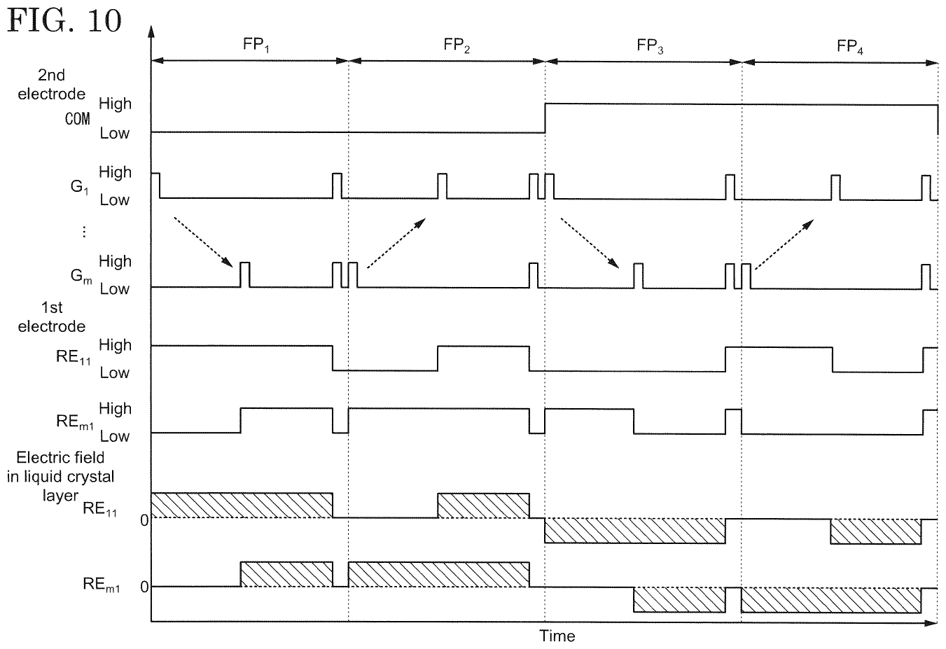

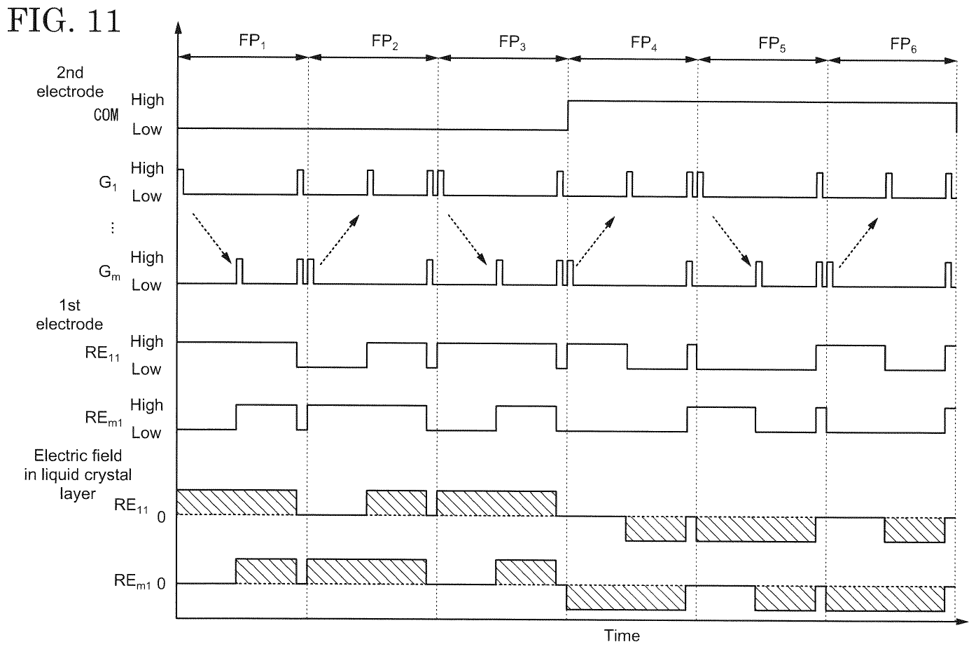

Conversely, the polarity of the common potential may be inverted every two or three frame periods, while the scanning direction may be inverted every frame period. As examples of these cases, the case where j and k are respectively 2 and 1 is shown in FIG. 10, and the case where j and k are respectively 3 and 1 is shown in FIG. 11. In the former example, the polarity of the common potential is inverted every two frame periods, while the scanning direction is inverted every frame period. In this case, the row dependences of the effective voltage and the electric field applied to the liquid crystal layer 136 can also be canceled by accumulating a plurality of frame periods (here, four frame periods including at least the first frame period FP₁ to the fourth frame period FP₄). In the latter example, the polarity of the common potential is inverted every three frame periods, while the scanning direction is reversed every frame period. In this case, the row dependences of the effective voltage and the electric field applied to the liquid crystal layer 136 can also be canceled by accumulating a plurality of frame periods (here, 6 frame periods including at least the first frame period FP₁ to the sixth frame period FP₆).

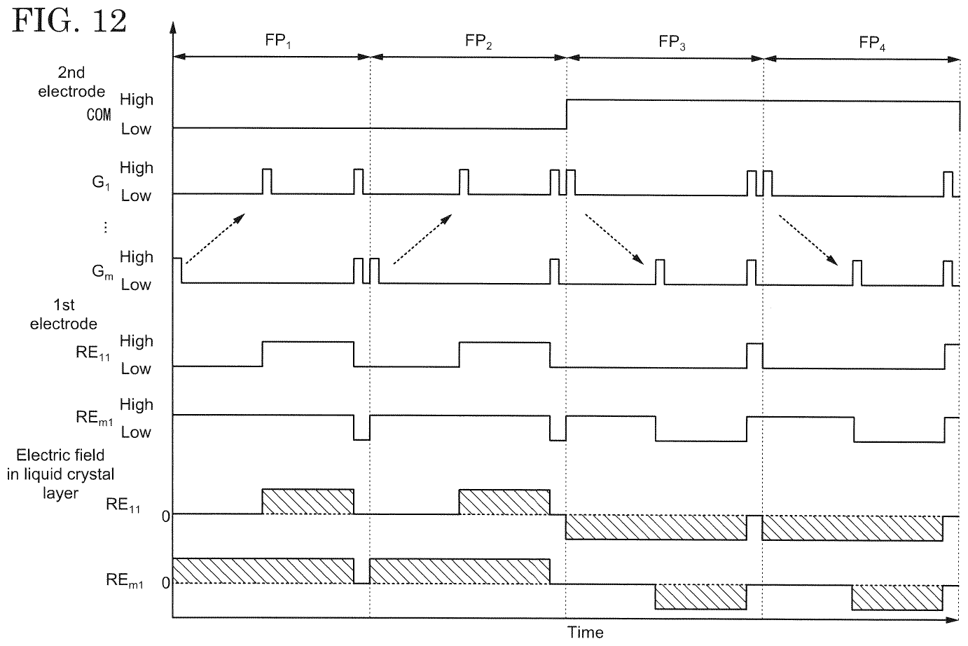

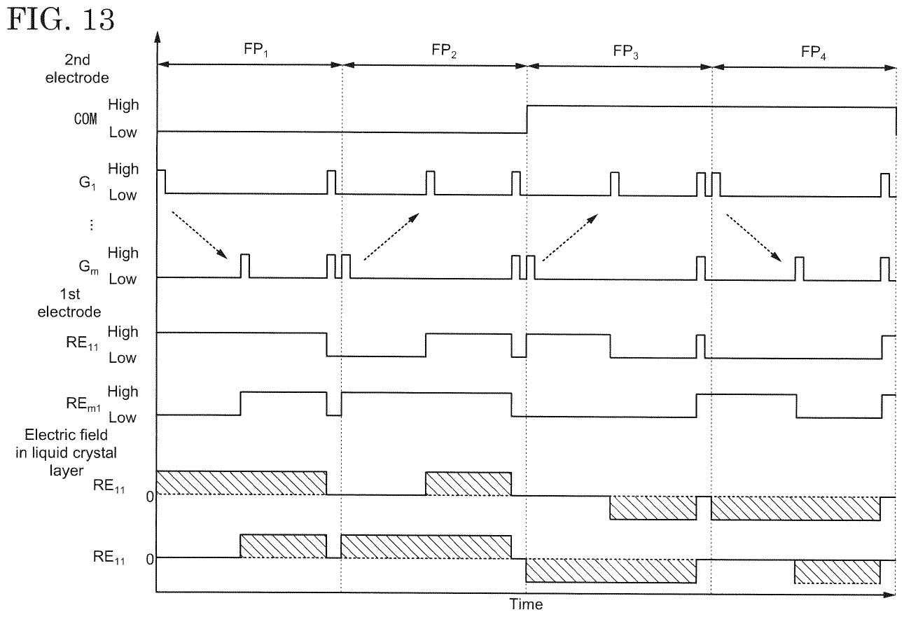

Alternatively, the scanning direction may be inverted every multiple frame periods. As an example of this case, the case where j and k are both 2 is shown in FIG. 12. In this example, the polarity of the common potential and the scanning direction are inverted every two frame periods. In this case, the row dependences of the effective voltage and the electric field applied to the liquid crystal layer 136 can also be canceled by accumulating a plurality of frame periods (here, four frame periods including at least the first frame period FP₁ to the fourth frame period FP₄). Note that, in the example shown in FIG. 12, the scanning direction is inverted at the same time as the polarity of the common potential is inverted, and the scanning directions are opposite to each other between two consecutive frames in which the polarity of the common potential is inverted. However, the scanning direction may be the same over two consecutive frames in which the polarity of the common potential is inverted, and the polarity of the common potential may be identical to each other between two consecutive frame periods in which the scanning direction is inverted as shown in FIG. 13.

As described above, in the driving method of the radio-wave reflector 100 according to an embodiment of the present invention, not only is the potential (common potential) of the second electrode 140 shared by the plurality of radio-wave reflecting elements 130 inverted every frame period or every multiple frame periods, but the order in which the scanning signals are supplied to the scanning lines is also inverted every frame period or every multiple frame periods. Adoption of this driving method not only enables the generation of a large electric field in the liquid crystal layer 136, but also allows the row dependences of the effective voltage and the electric field applied to the liquid crystal layer 136 to be canceled, resulting in the prevention of degradation of reflection characteristics.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of the radio-wave reflecting element and the radio-wave reflector of each embodiment is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. A driving method of a radio-wave reflector comprising:
a first scanning line to a mth scanning line;
a first signal line to a nth signal line; and
a plurality of radio-wave reflecting elements electrically connected to respective scanning lines and signal lines and each comprising a first electrode, a second electrode and a liquid crystal layer sandwiched by the first electrode and the second electrode,
the driving method comprising:
supplying a common potential to the second electrode over a plurality of continuous frame periods;
supplying scanning signals to the first scanning line to the mth scanning line in each of the plurality of frame periods; and
supplying control signals to the plurality of radio-wave reflecting elements through the first signal line to the nth signal line in each of the plurality of frame periods,
wherein a polarity of the common potential is inverted every j frame periods,
the scanning signals are supplied in a first order from the first signal line to the nth signal line or a second order from the nth signal line to the first signal line,
the first order and the second order are interchanged every k frame periods,
m and n are each selected from natural numbers equal to or greater than 2, and
j and k are selected from natural numbers equal to or greater than 1.

2. The driving method according to claim 1,
wherein j and k are the same as each other.

3. The driving method according to claim 1,
wherein j and k are different from each other.

4. The driving method according to claim 1,
wherein a polarity of a potential of the control signals is inverted along with the inversion of the polarity of the common potential.

5. The driving method according to claim 1, further comprising setting a potential of the first electrode so as to be the same as the common potential after supplying the control signals through the first signal line to the nth signal line in each of the plurality of frame periods.

6. The driving method according to claim 1,
wherein the first electrode and the second electrode are each configured to block visible light.

7. The driving method according to claim 1,
wherein the plurality of radio-wave reflecting elements is arranged in a matrix shape with m rows and n columns, and
potentials of the control signals are changed periodically and stepwise in a row direction and/or a column direction.
